(19) United States
(12) Patent Application Publication
(10) Pub. No.: US 2005/0046743 A1
(43) Pub. Date: Mar. 3, 2005

(54) Image signal processing circuit

(76) Inventor: Satoru Saito, Fujioka-shi (JP)

Correspondence Address: Jonathan P. Osha;Osha & May L.L.P., Suite 2800, 1221 McKinney St., Houston, TX, 77010, US

(21) Appl. No.: 10/933,001

(22) Filed: Sep. 2, 2004

(30) Foreign Application Priority Data
Sep. 2, 2003 (JP) JP2003-310759

(51) Int. Cl. H04N 11/20

(52) U.S. Cl. 348/452; 348/448

(57) ABSTRACT

An interlace image signal for four fields stored in an image memory is read out on a line-by-line basis and stored in an IP conversion data buffer. An output signal is a progressive image signal whose one horizontal period is twice that of an interlace image signal which is an input signal. Accordingly, reading of data from the IP conversion data buffer is made to correspond to one horizontal period on the output side at the time of outputting, and the signal which is read out is subjected to IP conversion and written into an output data buffer. By reading data from the output data buffer while data is being written into the output data buffer, the capacity of the output data buffer can be reduced to that corresponding to two horizontal lines.

The entire disclosure of Japanese Patent Application No. 2003-310759 including specification, claims, drawings and abstract is incorporated herein by reference in its entirety.

### BACKGROUND OF THE INVENTION

1. Field of the Invention

The present invention relates to an image signal processing circuit which performs image signal processing for converting an interlace image signal into a progressive image signal, so-called “IP conversion”.

2. Description of Related Art

Conventional television signals include an interlace image signal of the NTSC system or the like. Such an interlace signal comprises, for one frame of a television signal, odd field signals corresponding to odd-numbered horizontal scanning lines and even field signals corresponding to even-numbered horizontal scanning lines. On the television screen, the odd field signals and the even field signals are sequentially displayed in either of these two fields, namely in alternate scanning lines offset from each other by one horizontal scanning line. In the NTSC system, display of one field lasts 1/60 th of a second, and display of one frame is therefore completed in 1/30 th of a second.

Here, the resolution of the television screen can be increased if the signals concerning all the horizontal scanning lines are replaced by new image signals at each display which occurs every 1/60 seconds.

For this purpose, an apparatus has been known which uses interpolation to convert an interlace image signal for all the horizontal scanning lines into a progressive image signal, and creates a display accordingly. More specifically, with regard to a horizontal scanning line for which no corresponding interlace signal exists, interpolation is performed using signals in the above and below horizontal scanning lines in the same field, or using signals in the corresponding scanning line in the previous and following fields, thereby generating a signal for the target scanning line, which is a progressive image signal. This progressive signal enables high resolution display which can be observed clearly even in a large size screen.

The IP conversion for converting an interlace image signal into a progressive image signal as described above is disclosed in publications such as Japanese Patent Laid-Open Publications No. 2002-185933, No. 2002-112202, No. 2002-64792, No. 2001-339694, and others.

The above-described related art, however, has a problem in that data corresponding to two lines, namely a line for the original signal and a line for an interpolated signal, are obtained by the IP conversion and written into an output buffer corresponding to the two lines, and when the writing is completed, the data are read out from the buffer for output. In other words, in the related art, an output buffer for writing which corresponds to two lines and an output buffer for reading which corresponds to two lines, namely output buffers corresponding to a total of four lines are prepared, and reading and writing is alternately performed by two lines. As a result, a memory corresponding to four lines is required as an output buffer.

### SUMMARY OF THE INVENTION

According to one aspect of the present invention, reading of an interlace image signal and an IP conversion process is performed in synchronization with the horizontal period of a progressive image signal on the output side. It is therefore possible to perform writing of data in the output data buffer and reading of data from the output data buffer at the same rate, which allows reading of data from a single buffer while data are being written into the same single buffer. As a result, the capacity required for the output data buffer can be decreased.

In IP conversion in which interpolation data for one line are generated from interlace image signal data corresponding to four lines and output along with the original data for one line, an output data buffer corresponding to four lines is conventionally required. According to the present invention, the capacity required for such an output data buffer can be decreased to that corresponding to two lines.

### BRIEF DESCRIPTION OF THE DRAWINGS

A preferred embodiment of the present invention will be described in detail based on the following drawings, wherein:

FIG. 1 is a view showing a conceptual structure for IP conversion;

FIG. 2 is a view showing a hardware structure for IP conversion;

FIG. 3 is a view showing a data conversion state;

FIG. 4 is a view showing another example state of data conversion; and

FIG. 5 is a view showing still another example state of data conversion.

### DETAILED DESCRIPTION OF PREFERRED EMBODIMENT

A preferred embodiment of the present invention will be described in further detail with reference to the accompanying drawings.

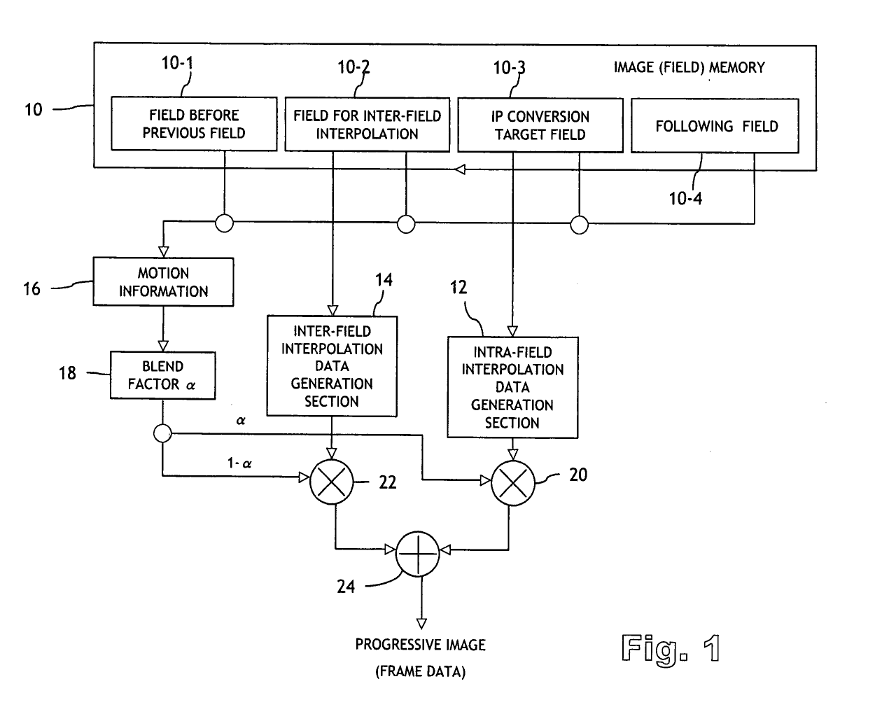

FIG. 1 schematically shows outline of an interpolation process according to one embodiment of the present invention. An image memory 10 sequentially stores an interlace image signal corresponding to four fields. In this example, a memory area 10-1 stores data of the field which appeared earliest, and memory areas 10-2, 10-3, and 10-4 sequentially store data of the subsequent fields in this order. The field concerning the memory area 10-3 is a target field of IP conversion. Further, the memory areas 10-1 to 10-4 sequentially store an interlace signal, and therefore alternately store data of the odd number field and data of the even number field.

The data stored in the memory area 10-3, which are data of the IP target field, are supplied to an intra-field interpolation data generation section 12. The intra-field interpolation data generation section 12 outputs, as output data for a horizontal scanning line (horizontal line) having no corresponding data, data for the previous horizontal line once again. Here, it is also possible to generate image data for the target horizontal line based on data for the adjacent horizontal lines above and below the target line, if the circuit structure permits.

The data stored in the memory area 10-2 concerning the field coming just before the IP target field (that is, the previous field) are supplied to an inter-field interpolation generation section 14. Because this memory area 10-2 stores data concerning the target horizontal line to be interpolated, such data are output as they are, for example.

The data stored in the memory areas 10-1 to 10-4 are supplied to a motion information detection section 16. The motion information detection section 16 compares the data of the four fields and detects motion of the image based on the matching degree of images among the fields. The result of detection is supplied to a blend factor a generation section 18, which generates a blend factor a which becomes greater as the motion is bigger in accordance with a predetermined method.

The data subjected to intra-field interpolation in the intra-field interpolation data generation section 12 are supplied to a multiplier 20, where a blend factor α is multiplied with the data of the target horizontal line obtained by the interpolation. On the other hand, the data in the inter-field interpolation data generation section 14 are supplied to a multiplier 22, where (1−α) is multiplied with the supplied data. The outputs from these multipliers 20 and 22 are supplied to an adder 24, where an adding process is performed with regard to the data for the horizontal line to be interpolated, and a progressive image signal which has been interpolated are output.

Although in the above example the original data of the horizontal line which do not require processing also pass through the intra-filed interpolation data generation section 12 or the like, such data can also be temporarily separated and inserted back later.

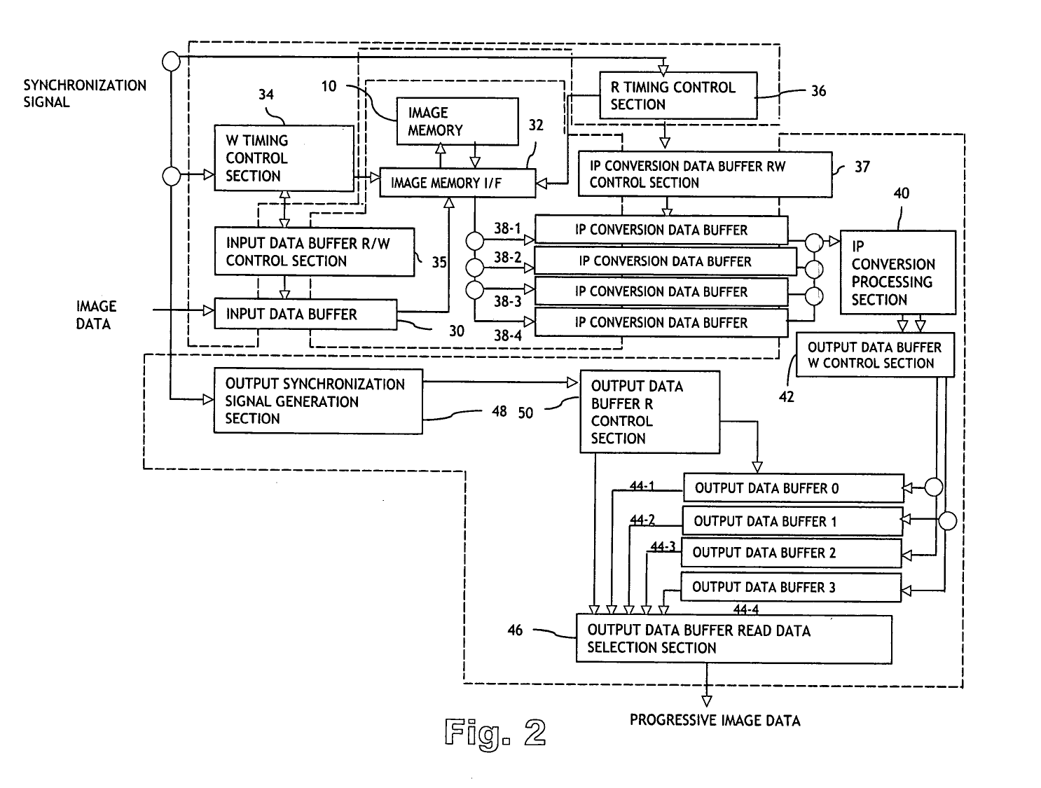

FIG. 2 shows a detailed structure of an apparatus for performing the above operation. Image data are written into the image memory 10 via an input data buffer 30 and through an image memory I/F 32. Also, a horizontal synchronization signal (Hsync) indicative of the timing in the horizontal and vertical directions with regard to the image data is supplied to a W timing control section 34. The W timing control section 34 controls writing timing and reading timing of the image data into and from the input data buffer 30 via an input data buffer R/W control section 35. The W timing control section 34 also controls the image memory I/F 32 to control the writing timing of the image data transmitted from the input data buffer 30 into the image memory 10.

The synchronization signal is also supplied to an R timing control section 36. The data stored in the image memory 10 are supplied to four IP conversion data buffers 38 via the image memory I/F 32. Specifically, data for the four fields are stored in the image memory 10, as shown in FIG. 1, and are supplied to the corresponding one of the four IP conversion data buffers 38, respectively. The R timing control section 36 controls reading of data by the image memory I/F 32 and also controls writing of the data into the IP conversion data buffers 38 via an IP conversion data buffer R/W control section 37.

The data in the IP conversion data buffer 38 are then supplied to an IP conversion processing section 40, where an operation for interpolation is performed. More specifically, the IP conversion processing section 40 performs processes such as intra-field interpolation, inter-field interpolation, calculation of a blend factor, generation of interpolation data, and so on. As a result of these processes, data are generated for the horizontal line having no corresponding data, and both the interpolated data and the original data for the horizontal line are supplied, via the output data buffer W control section 42, to four output data buffers (0) 44-1 to (3) 44-4. In FIG. 2, one of the two lines extending from the IP conversion processing section 40 corresponds to data of a horizontal line which have been interpolated and the other corresponds to the original data for the horizontal line. Then, the data for the two horizontal lines (one for the interpolated data and the other for the original data) which are output from the output data buffer W control section 42 are sequentially written into a pair of the output data buffer (0) 44-1 and the output data buffer (1) 44-2 and a pair of the output data buffer (2) 44-3 and the output data buffer (3) 44-4.

The output from these four output data buffers (0) 44-1 to (3) 44-4 are supplied to an output data buffer read data selection section 46.

Here, a horizontal synchronization signal is supplied to an output synchronization signal generation section 48, where an output synchronization signal which is synchronous with an input synchronization signal and which has a frequency twice the input synchronization signal is generated. The output horizontal synchronization signal is supplied to an output data buffer R control section 50. The output data buffer R control section 50 controls the output timing of the output data from the output data buffers 44-1 to 44-4, and also controls selection performed by the output data buffer read data selection section 46. Consequently, the output data buffer read data selection section 46 outputs a progressive image data signal having a signal for every horizontal line, in synchronization with the output horizontal synchronization signal.

In this embodiment, writing of data into the input data buffer 30 is performed in synchronization with a interlace clock (an input pixel clock) which is a transmission clock of an interlace image signal, and writing/reading of data with respect to the image memory 10 is performed in accordance with an operation clock for the image memory. The input data buffer 30 absorbs a difference in rates between the interlace clock and the operation clock for the image memory. A horizontal synchronization signal and a vertical synchronization signal which are in synchronous with the interlace clock of the interlace image signal are supplied to the W timing control section 34 for controlling writing of the image data into the input data buffer 30 via the input data buffer R/W control section 35. Further, while the input data buffer R/W control section 35 controls reading of the data from the input data buffer 30 in accordance with the operation clock for the image memory, writing of the image data into the image memory 10 is controlled corresponding to the interlace clock because the timing of the interlace clock is also input to the input data buffer R/W control section 35 and the image memory I/F 32. Further, the horizontal and vertical synchronization signals of the interlace image signal are also supplied to the R timing control section 36, which then controls reading of data from the image memory 10 so as to correspond to the interlace clock. In addition, the vertical and horizontal synchronization signals of the interlace image signal are input to the output synchronization signal generation section 48, which generates horizontal and vertical synchronization signals for progressive output having a frequency which is twice (or having a half period of) the vertical and horizontal synchronization signals of the interlace image signal, based on the vertical and horizontal synchronization signals of the interlace image signal. Then, reading of data from the IP conversion data buffer 38 and the subsequent processes are performed based on a progressive clock corresponding to the horizontal and vertical synchronization signals for progressive output, which is twice the rate of the vertical and horizontal synchronization signals of the interlace image signal.

Accordingly, it is possible to perform the IP conversion process at a rate corresponding to a clock of the progressive image data signal, so that, even when reading from the output data buffer 44 starts while data are being written into the output data buffer 44, the reading address will not progress ahead of the writing address. It is therefore possible to output a progressive image signal from the output data buffer having data capacity corresponding to two lines.

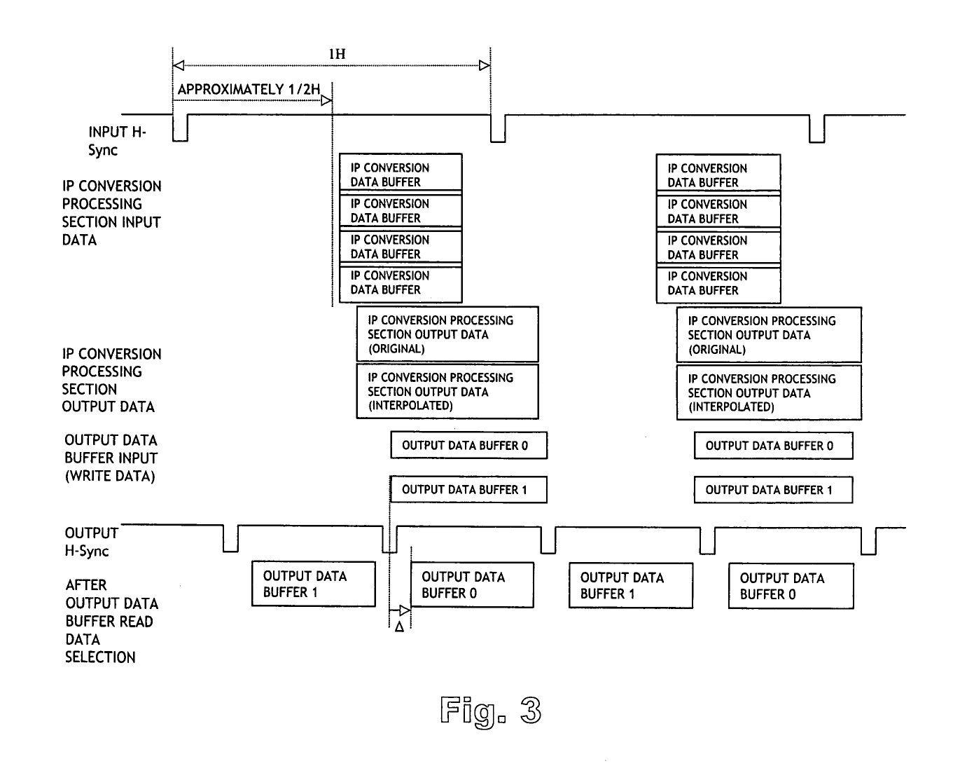

With reference to FIG. 3, movement of data will be described. Four-field information data are stored within the image memory 10, and data for one line are extracted from each field and supplied to the IP conversion data buffer 38. For example, data for the n-th line in the target field of IP conversion, data for the n-th line in the field before the previous field of the target field which are stored in the memory area 10-1, data for the (n+1)-th line (line for interpolation) in the previous field (the field coming just before the target field), and data for the (n+1)-th line in the field following the target field are supplied for storage into the four IP conversion data buffers 38, respectively. Then, IP conversion processing section 40 outputs the data for the n-th line in the target field (the original data) and the data for the (n+1)-th line (the interpolated data) obtained by interpolation in which the data subjected to intra-field interpolation (obtained from the previous line) and the data subjected to inter-field interpolation (obtained from the same line in the previous field) are proportionally distributed in accordance with the motion, and the output data are written into the output data buffers 44-1 and 44-2.

Then, the data written into the output data buffers 44-1 and 44-2 are sequentially output in accordance with an output horizontal synchronization signal.

Here, because writing of data with respect to the IP conversion data buffer 38 is performed in accordance with a clock corresponding to an input horizontal synchronization signal, the writing is completed within a 1 H period on the input side. On the other hand, reading of data out of the IP conversion data buffer 38 starts after elapse of approximately a half the horizontal synchronization period (1 H) on the input side. In this case, a reading clock is based on the horizontal synchronization signal on the output side, and the reading is completed within the remaining half of the 1 H on the input side. Then, although the IP conversion process also shifts in time, it is also completed within a (½) H on the input side, and the data are written into the output data buffer 44. Here, while the writing of data into the IP conversion data buffer 38 and the reading of data out of the IP conversion data buffer 38 are completed nearly simultaneously, it is set that the reading address does not progress ahead of the writing address.

Then, reading of data out of the output data buffer 44 starts with a delay of a predetermined time Δ with respect to the writing of data into the output data buffer 44. The data writing rate is basically the same as the data reading rate, so that a reading position does not progress ahead of a writing position and data subjected to IP conversion can be read sequentially. Consequently, reading of data from one output data buffer 44 is completed within 1 H on the output side. Then, in the following 1 H on the output side, data reading is performed with respect to another data buffer 44 in which data have been written, but from which data have not output yet. By repeating the above process, it is possible to output a converted progressive image signal using only two output data buffers each corresponding to one line.

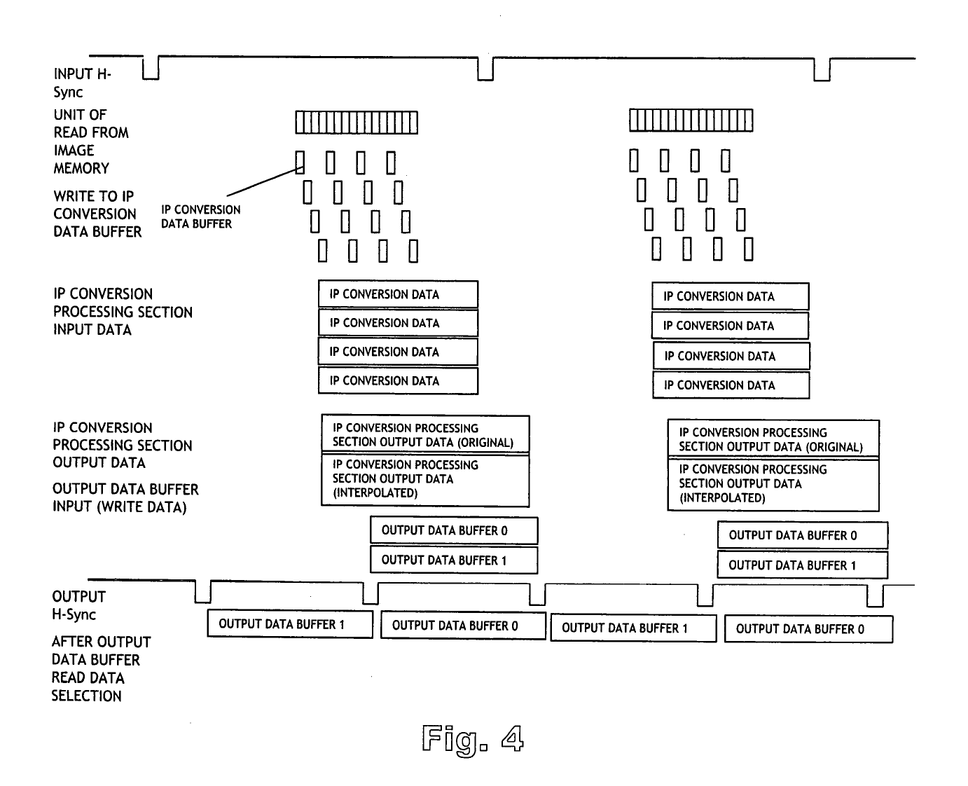

FIG. 4 shows an example in which the image memory allows extra access. In this example, data corresponding to (¼) H are sequentially read from the four field areas of the image memory 10, and are written into the four areas of the IP conversion data buffer 38. Then, IP conversion is initiated by reading data from the IP conversion data buffer 38. In this manner, reading from the image memory 10 and writing into the IP conversion data buffer is sequentially repeated, thereby performing IP conversion.

By dividing data into data corresponding to (¼) H for reading from the image memory 10 and sequentially processing the data as described above, a capacity corresponding data for 1 H is not required for the IP conversion data buffer 38. More specifically, the capacity of the IP conversion data buffer 38 can be reduced to that corresponding to (½) H, when the IP conversion data buffer 38 has a two-bank structure in which (¼) H is used alternately.

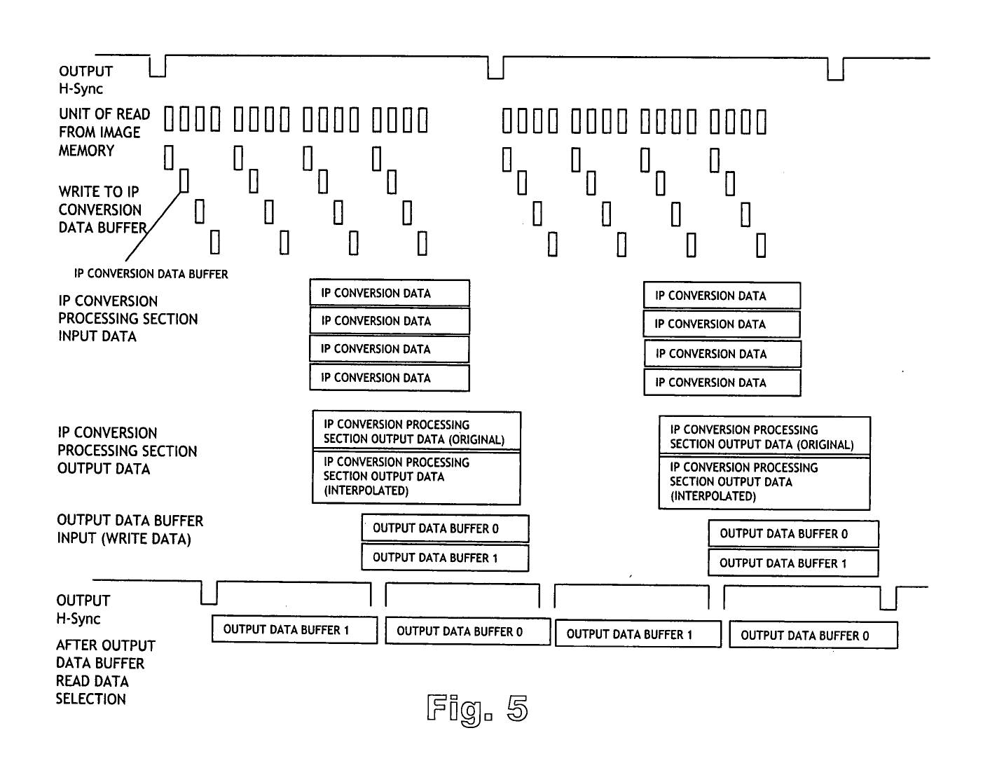

FIG. 5 shows still another example in which reading from the image memory 10 is performed intermittently during approximately 1 H on the input side. With this structure, it is possible to prevent the concentration of access more effectively compared with the example in FIG. 4. However, because writing of data into the IP conversion data buffer 38 is also performed intermittently, the data capacity corresponding to 1 H is required for the IP conversion data buffer 38. The writing of data into the IP conversion data buffer 38 and the subsequent processes are similar to those in the example of FIG. 4.

While in the above examples, it has been described that original data and the interpolated data output from the IP conversion processing section are always obtained in the same manner, they are actually obtained in slightly different manners. Specifically, when the target field of IP conversion is an odd field, data for the line below the original line are generated by interpolation, whereas when the target field is an even field, data for the line above the original line are generated by interpolation. Accordingly, for processes involving an odd field, the original data are output first, and the interpolated data are then output from the output data buffer 44 after the original data. On the other hand, for processes involving an even field, the interpolated data are output first, and then the original data are output from the output data buffer 44.

While the preferred embodiment of the present invention is described above using specific terms, such description is for illustrative purposes only, and it is to be understood that changes and variations may be made without departing from the spirit or scope of the appended claims.

1. An image signal processing circuit for converting an interlace image signal into a progressive signal, comprising:
an image memory for storing an interlace image signal for a plurality of fields;
a converting data buffer for storing a signal for each field which is read from the image memory;
an IP conversion circuit which reads a signal from the converting data buffer during a period corresponding to a half of one horizontal period of the interlace image signal and performs an IP conversion process with respect to the signal which is read, for converting an interlace image signal into a progressive image signal, to obtain a progressive image signal;
an output data buffer in which the progressive image signal obtained by the IP conversion circuit is written for storage during a period corresponding to a half of one horizontal period of the interlace image signal; and
a read circuit which starts reading data from the output data buffer while a signal is being written into the output data buffer from the IP conversion circuit and which reads data within the output data buffer during a period corresponding to a half of one horizontal period of the interlace image signal.

2. An image signal processing circuit according to claim 1, wherein
reading of the image signal from the image memory and writing of the image signal into the converting data buffer is performed during a period corresponding to one horizontal period of an interlace image signal.

3. An image signal processing circuit according to claim 1, wherein
reading of the image signal from the image memory and writing of the image signal into the converting data buffer is performed during a period corresponding to a half of one horizontal period of an interlace image signal.

4. An image signal processing circuit according to claim 1, wherein
reading of the image signal from the image memory and writing of the image signal into the converting data buffer is performed intermittently during a period corresponding to one horizontal period of an interlace image signal.

5. An image signal processing circuit according to claim 1, wherein
writing of data into the converting data buffer is performed using a signal which is in synchronization with the interlace image signal and reading of data from the converting data buffer is performed using a signal which is in synchronous with the progressive image signal.
